(19) United States
(12) Patent Application Publication
(10) Pub. No.: US 2010/0170800 A1
(43) Pub. Date: Jul. 8, 2010

(54) COMPOSITE MATERIAL AND METHOD OF MANUFACTURING THE SAME

(75) Inventors: Yoon-chul SON, Yongin-si (KR); Yong-chul KIM, Yongin-si (KR); In-taek HAN, Yongin-si (KR)

Correspondence Address: CANTOR COLBURN, LLP, 20 Church Street, 22nd Floor, Hartford, CT, 06103, US

(73) Assignee: SAMSUNG ELECTRONICS CO., LTD, Suwon-si (KR)

(21) Appl. No.: 12/562,789

(22) Filed: Sep. 18, 2009

(30) Foreign Application Priority Data
Jan. 8, 2009 (KR) 10-2009-0001601

(51) Int. Cl. C25D 9/02; C25D 9/00; C25D 9/04; B82B 3/00; B82B 1/00

(52) U.S. Cl. 205/50; 205/316; 205/317; 977/742; 977/750; 977/752; 977/746

(57) ABSTRACT

A composite material comprising a metal layer, a plurality of carbon nanotubes in the metal layer, and a plurality of nucleic acids in the metal layer. Also disclosed is a method of manufacturing the composite material and an electronic device including the composite material.

### CROSS-REFERENCE TO RELATED APPLICATION

This application claims priority to Korean Patent Application No. 10-2009-0001601, filed on Jan. 8, 2009, and all the benefits accruing therefrom under 35 U.S.C. §119, the content of which in its entirety is herein incorporated by reference.

### BACKGROUND

1. Field

One or more embodiments relate to a composite material and a method of manufacturing the same.

2. Description of the Related Art

Carbon nanotubes are useful in a variety various fields, particularly in electronic materials, due to their excellent electrical and thermal properties, high hardness and strength. In general, carbon nanotubes are synthesized by chemical vapor deposition at high temperature. When formed on a substrate, carbon nanotubes are not densely packed, which results in empty space between the individual carbon nanotubes. Furthermore, the as-synthesized carbon nanotubes tend to bind to each other by forces such as Van der Waals forces to form bundles. It would be desirable to fill the empty spaces between the carbon nanotubes, or the bundles of the carbon nanotubes would desirably be separated in order to effectively utilize the carbon nanotubes in applications such as electronic materials.

When carbon nanotubes are embedded in polymer, oxide or metal matrices, one or more of the electrical, thermal or mechanical properties of the matrices may be improved. Because carbon nanotubes are embedded in polymer matrices using a high-temperature process such as sintering and hot-pressing, the process of embedding the carbon nanotubes in the matrices is complicated and the carbon nanotubes are not easily separated from each other.

Accordingly there is a need for composite materials having increased density in which the carbon nanotubes are individually dispersed, that is, separated from each other.

### SUMMARY

One or more embodiments comprise a composite material having a novel structure.

One or more embodiments comprise a method of manufacturing the composite material.

Additional aspects, features and advantages will be set forth in the description which follows.

According to one or more embodiments, there is provided a composite material comprising: a metal layer; a plurality of carbon nanotubes in the metal layer; and a plurality of nucleic acids in the metal layer.

According to one or more embodiments, there is provided a method of manufacturing a composite material, the method comprising: immersing a substrate in a plating solution; and forming a plating layer on the immersed substrate, wherein the plating solution comprises a plurality of carbon nanotubes, a plurality of nucleic acids, and a plurality of metal ions.

Also disclosed is an electronic device including the composite material.

### BRIEF DESCRIPTION OF THE DRAWINGS

These and/or other aspects will become apparent and more readily appreciated from the following description of the embodiments, taken in conjunction with the accompanying drawings, in which:

FIG. 1 is a scanning electron microscope (“SEM”) image of the surface of an exemplary embodiment of a composite material manufactured according to Example 1; and

FIG. 2 is a SEM image of the surface of an exemplary embodiment of a composite material manufactured according to Example 2.

### DETAILED DESCRIPTION

Reference will now be made in further detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects, features and advantages of the present description.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

A composite material and a method of manufacturing the composite material according to various exemplary embodiments will now be described in further detail.

The composite material according to an embodiment comprises: a metal layer; a plurality of carbon nanotubes in the metal layer; and a plurality of nucleic acids in the metal layer. Because the metal layer of the composite material includes the carbon nanotubes and the nucleic acids, and the carbon nanotubes are individually dispersed in the metal layer, the metal layer has a relatively dense structure. Thus, the composite material may be efficiently used as a material for forming electronic materials such as wires, electrodes and thin films. The metal layer may be a metal thin film, a metal bulk material, or the like.

As used herein, reference to “a plurality of carbon nanotubes in the metal layer” and “a plurality of nucleic acids in the metal layer” means that the carbon nanotubes and the nucleic acids may be fully or partially contained within the metal layer. Thus, in one embodiment, all of the carbon nanotubes are entirely contained within the metal layer. In another embodiment, a portion (e.g., a majority) of the carbon nanotubes are entirely contained within the metal layer and another portion (e.g., a minority) of the carbon nanotubes are partially within the metal layer and partially exposed on the surface of the metal layer.

A portion of or the entirety of each of the carbon nanotubes in (e.g., fully contained in) the metal layer may be coated with the at least a portion of the nucleic acids. While not wanting to be bound by theory, it is believed that because both a base of the nucleic acids and a sidewall of the carbon nanotubes include an aromatic ring having delocalized π-electrons, at least a portion of the surface of the carbon nanotubes may be contacted with (e.g., coated with) the nucleic acids by a π-π stacking interaction between the base of the nucleic acids and the sidewalls of the carbon nanotubes. For example, one or more of the nucleic acids may spirally wind around a portion of the surface of the carbon nanotubes or the entire surface of the carbon nanotubes. Because the nucleic acids are contacted with (e.g., wind around) the surface of each of the carbon nanotubes, the carbon nanotubes do not form bundles, but rather are individually dispersed in the metal layer.

The metal layer of the composite material may include at least one metal selected from the group consisting of a Group 1 to 16 element, wherein Groups 1 to 16 refer to Groups in the Periodic Table of the Elements. For example, the metal layer may include at least one metal selected from the group consisting of: at least one alkali metal selected from the group consisting of Li, Na, K, Rb, Cs and the like; at least one rare-earth metal selected from the group consisting of Be, Mg, Ca, Sr, Ba and the like; at least one transition metal selected from the group consisting of Co, Cr, Fe, Ni, Mn, Cu, Hg, Pt, Ag, Cd, Zn, Sc, Ti, V, Y, Zr, Nb, Mo, Tc, Ru, Rh, Pd, Lu, Hf, Ta, W, Re, Os, Ir, Au, Lr, Rf, Db, Sg, Bh, Hs, Mt, Ds, Rg, Uub and the like; and at least one metal selected from the group consisting of Pb, Sn, Ge and the like. In this regard, the metal layer may comprise any metal that is ionized in a solution without limitation.

The metal layer may be a plating layer. The plating layer may be formed using any available plating method used in the art, for example, by electroplating or electroless plating. Advantageously, the metal layer has a dense structure. In another embodiment, pores are not formed in the metal layer. In a particularly advantageous embodiment, the metal layer may be both dense and without pores. The thickness of the metal layer may be about 0.01 nanometer (nm) to about 100 millimeters (mm), specifically about 0.1 nm to about 10 mm, more specifically about 1 micrometer to about 1 mm, but is not limited thereto. The plating layer may have a single-layered or multi-layered structure.

The metal layer may further include at least one element selected from the group consisting of P, B, N, C, O and H. These elements may be contained in a reducing agent used to reduce the metal ions during the formation of the plating layer using electroless plating. However, any element that is contained in a compound used as the reducing agent of the metal ions may be used without limitation. The reducing agent may be contained in the metal layer with the metal reduced from the metal ions due to the reducing agent.

The nucleic acids may include at least one nucleic acid selected from the group consisting of DNA, complementary DNA (“cDNA”), chloroplast DNA (“cpDNA”), multicopy single-stranded DNA (“msDNA”), mitochondrial DNA (“mtDNA”), RNA, messenger RNA (“mRNA”), transfer RNA (“tRNA”), glycerol nucleic acid (“GNA”), locked nucleic acid (“LNA”), peptide nucleic acid (“PNA”), threose nucleic acid (“TNA”) and the like. However, any known type of nucleic acids may also be used without limitation.

The nucleic acids may include at least one heterocyclic base having nitrogen selected from the group consisting of adenine (“A”), guanine (“G”), thymine (“T”), cytosine (“C”) and uracil (“U”). In addition, the nucleic acids may further include a pentose sugar and/or phosphate in addition to the heterocyclic base.

The carbon nanotubes may include at least one carbon nanotube selected from the group consisting of a single-wall carbon nanotube, a double-wall carbon nanotube, a multi-wall carbon nanotube, a metallic carbon nanotube, a semiconducting carbon nanotube, and the like. However, any known type of carbon nanotube may also be used without limitation.

The amount of the carbon nanotubes may be about 0.1% to about 80% by weight, specifically about 1% to about 60%, more specifically about 5% to about 30%, based on the total weight of the composite material.

The composite material may further include a substrate, wherein the metal layer is disposed (e.g., formed) on a least one surface of the substrate. The substrate may be a conductive substrate or an insulating substrate having a conductive coating layer disposed (e.g., formed) thereon. For example, the substrate may be a metal substrate, a glass substrate coated with metal (e.g., a conductive metal), a glass substrate coated with a transparent oxide, a semiconductor substrate, or the like or a combination thereof. Any substrate on which a metal plating layer may be disposed (e.g., formed) may be used without limitation. in a specific embodiment an activated coating layer may further be formed on one surface of the substrate on which the metal layer will be formed, to facilitate formation of the metal layer. The activated coating layer may include Sn, Pd, or the like or a combination thereof. In addition, the composite material may further comprise an additional metal layer on the surface of the metal layer. For example, an additional coating layer comprising a pure metal may further be disposed (e.g., formed) on the metal layer so as to change physical properties of the surface of the composite material.

An electronic material according to an embodiment may include the composite material. The electronic material may be a material for forming wires, electrodes, thin films or the like, but is not limited thereto. An electronic device comprising the electronic material may be a wire, electrode, metal thin film or the like. Electrical and/or physical characteristics of such electronic devices may be improved by using the composite material. Electronic articles comprising the electronic devices are also contemplated, for example transistors, batteries, and the like.

A method of manufacturing a composite material according to an embodiment comprises: immersing a substrate in a plating solution; and forming a plating layer on the immersed substrate. The plating solution includes a plurality of carbon nanotubes, a plurality of nucleic acids and a plurality of metal ions. In an embodiment of the method, the composite material is manufactured using a wet plating method, advantageously without using a sintering process at high temperature. Thus, the composite material may be efficiently utilized in the manufacture of various electronic devices.

In an embodiment of the method, the plating solution comprising carbon nanotubes, nucleic acids, and metal ions as described above is prepared, and the substrate is immersed in the plating solution. In the plating solution, the surface of the carbon nanotubes is contacted (e.g., coated) with the nucleic acid so that a portion of or all of the carbon nanotubes are individually dispersed in the plating solution. Thus, the plating solution does not require a surfactant to partially, substantially or entirely disperse the carbon nanotubes. Addition of a surfactant may decrease efficiency and speed of the plating process. The plating solution may further include an additive such as: an electrolyte to increase conductivity; and a complexing agent, such as a salt of citric acid, a salt of tartaric acid, sulfamic acid or the like, to facilitate precipitation of the metal ions. The pH of the plating solution may be controlled. Without being bound by theory, it is believed that the metal ions may form a complex with one or more of the nucleic acids contacting with (e.g., coated on) one or more of the carbon nanotubes. For example, a carbon nanotube/nucleic acid/metal ion complex may be formed. The carbon nanotube/nucleic acid/metal ion complex may have a plurality of metal ions on the surface of the complex. The plating solution may include a plurality of metal ions and complexes. It is theorized that the heterocyclic base of the nucleic acids readily binds to ions of metal such as Ag, Hg and Pt, and the phosphate group readily binds to ions of metal such as Li, Na and K. Again, while not wanting to be bound by theory, because the d orbital of a transition metal ion is partially empty, the transition metal ion may bind to at least two binding sites. For example, the transition metal ion may directly bind to the base of the nucleic acid and may indirectly bind to the phosphate group. The complex maintains the carbon nanotubes in an electrically positive state. The complex may vary according to the type of the nucleic acids and the metal ions. A plating layer may then be formed on the substrate immersed in the plating solution using various plating methods. The plating layer includes the carbon nanotubes and the nucleic acids.

The plating layer may be formed by electroplating or electroless plating. Electroplating is relatively inexpensive, and thus can be advantageous for at least that reason.

The electroplating may be performed by adding a plating solution to an electrolytic cell, immersing a cathode and an anode into the plating solution and supplying electric current thereto. Any conductive metal that is commonly used in electroplating may be used for the anode. For example, copper, nickel, chromium, zinc, cadmium, tin, gold, silver, rhodium, platinum, or the like or a combination thereof may be used for the anode. The metal used to form the anode may be the same as that used to form the plating layer. When the plating layer is precipitated on the cathode during the plating, the amount of the metal ions corresponding to the precipitated metal is decreased in the plating solution. Thus, from the anode, the oxidized metal ions are supplied to the plating solution to supplement the metal ions precipitated on the cathode. The metal of the anode is oxidized to form cations, that is, positively charged metal ions. The cations are reduced at the cathode to form the plating layer on the cathode. The metal used for the cathode may be the same as that used to form the plating layer, or the cathode may comprise various conductive substrates. For example, the cathode may comprise a stainless steel substrate, a copper-plated silicon wafer substrate, a nickel-plated silicon wafer substrate, an aluminum-plated silicon wafer substrate, a copper-plated glass substrate, a nickel-plated glass substrate, an indium tin oxide (“ITO”)-coated glass substrate, or the like or a combination thereof.

Conditions for the electroplating are not particularly limited and can be readily determined by one of ordinary skill in the art without undue experimentation. For example, the current density may be in the range of about 0.01 milliamperes per square decimeter (mA/dm²) to about 1000 A/dm², specifically about 0.1 mA/dm² to about 100 mA/dm², more specifically about 1 mA/dm² to about 10 mA/dm², the plating time may be about 0.01 second to about 1000 hours, specifically about 0.1 second to about 100 hours, more specifically about 1 second to about 10 hours, and the applied voltage may be about 0.01 millivolts (mV) to about 10000 volts (V), specifically about 0.1 mV to about 1000 V, more specifically about 1 mV to about 100 V.

The electroplating may further optionally include a pre-plating process such as strike plating to reduce unevenness and improve uniformity of the surface of the plating layer. Any pre-plating process that is commonly used in electroplating may be used. In addition, the plating solution may include at least two types of metal ions. A metal and/or alloy plating layer having a variety of compositions may be formed by selecting metal ions having various standard reduction potentials as is known in the art.

The composition of the plating solution used in the electroless plating may be the same as that of plating solutions commonly used in electroplating, except that the plating solution used in the electroless plating includes a reducing agent. In this regard, in electroless plating, the plating layer is formed by a reducing agent instead of electricity. Any reducing agent that is commonly used for electroless plating may be used. For example, the reducing agent may include at least one reducing agent selected from the group consisting of hypophosphite, borohydride, amine borane, hydrazine, formaldehyde, dimethylborane, dimethylamine borane (“DMAB”), cobalt borane, 2-oxazolidinone, and the like.

In one embodiment, a portion of or the entirety of each of the carbon nanotubes contained in the plating solution may be contacted (e.g., coated) with the nucleic acids. In another embodiment, only some (e.g., a majority) of the carbon nanotubes contained in the plating solution may be contacted (e.g., coated) with the nucleic acid over a portion of or the entirety of each of the contacted (e.g., coated) nanotubes. It is believed that all or a portion (e.g., a majority) of the carbon nanotubes are individually dispersed in the plating solution due to the contacting or coating with the nucleic acids.

The metal layer may be derived from ions of at least one metal selected from the group consisting of a Group 1 to 16 element. For example, the metal ions may include ions of at least one metal selected from the group consisting of: at least one alkali metal selected from the group consisting of Li, Na, K, Rb, Cs and the like; at least one rare-earth metal selected from the group consisting of Be, Mg, Ca, Sr, Ba and the like; at least one transition metal selected from the group consisting of Co, Cr, Fe, Ni, Mn, Cu, Hg, Pt, Ag, Cd, Zn, Sc, Ti, V, Y, Zr, Nb, Mo, Tc, Ru, Rh, Pd, Lu, Hf, Ta, W, Re, Os, Ir, Au, Lr, Rf, Db, Sg, Bh, Hs, Mt, Ds, Rg, Uub and the like; and at least one metal selected from the group consisting of Pb, Sn, Ge and the like. The oxidation number of the metal ions may be about +1 to about +3, specifically about 2, but is not limited thereto.

The nucleic acids may include at least one nucleic acid selected from the group consisting of DNA, complementary DNA (“cDNA”), chloroplast DNA (“cpDNA”), multicopy single-stranded DNA (“msDNA”), mitochondrial DNA (“mtDNA”), RNA, messenger RNA (“mRNA”), transfer RNA (“tRNA”), glycerol nucleic acid (“GNA”), locked nucleic acid (“LNA”), peptide nucleic acid (“PNA”), threose nucleic acid (“TNA”) and the like. Any known type of nucleic acids may also be used without limitation.

The nucleic acids may include at least one heterocyclic base having nitrogen selected from the group consisting of adenine (“A”), guanine (“G”), thymine (“T”), cytosine (“C”) and uracil (“U”). In addition, the nucleic acids may further include a pentose sugar and/or phosphate in addition to the heterocyclic base.

The carbon nanotubes may include at least one carbon nanotube selected from the group consisting of a single-wall carbon nanotube, a double-wall carbon nanotube, a multi-wall carbon nanotube, a metallic carbon nanotube, a semiconducting carbon nanotube and the like. However, any known type of carbon nanotube may be used without limitation.

The amount of the carbon nanotubes contained in the plating solution will depend on the desired electrical, physical and/or other desired characteristics of the composite, and may be, for example, in the range of about 0.1% to about 60% by volume, specifically about 1% to about 30% by volume, more specifically about 5% to about 20% by volume, based on the total volume of the plating solution.

The amount of the nucleic acids contained in the plating solution may be in the range of about 0.1% to about 50% by volume, specifically about 1% to about 40% by volume, more specifically about 5% to about 20% by volume, based on the total volume of the plating solution.

Hereinafter, one or more embodiments will be described in detail with reference to the following examples. However, these examples are not intended to limit the purpose and scope of the disclosed embodiments.

Preparation of Composite Material

### Example 1

### Electroplating

A 40 milligram (mg) amount of a single-wall carbon nanotube (Hipco, purity: 95%) and 40 mg of tRNA (Transfer RNA transferred from baker's yeast (S. cerevisiae), Sigma-Aldrich, CAS Number 9014-25-9) were added to 100 milliliters (ml) of deionized water to prepare a mixture. The mixture was mixed with 300 ml of a Ni electroplating solution (NiSO₄.6H₂O 300 grams per liter (g/L), NiCl₂.6H₂O 45 g/L, and H₃BO₃ 40 g/L) to prepare a plating solution. The plating solution was added to a plating bath, and a cathode and an anode were immersed in the plating solution. Then, a current of 20 mA/dm² was supplied thereto for 5 minutes to form a plating layer having a thickness of 1 micrometer (μm). A stainless steel substrate was used for the cathode, and a nickel bar was used for the anode.

### Example 2

### Electroless Plating

A 40 mg amount of a single-wall carbon nanotube (Hipco, purity: 95%) and 40 mg of tRNA (Transfer RNA transferred from baker's yeast (S. cerevisiae), Sigma-Aldrich, CAS Number 9014-25-9) were added to 100 ml of deionized water to prepare a mixture. The mixture was mixed with 300 ml of a Ni electroless plating solution (NaH₂PO₂.H₂O 10.5 g/L, NiCl₂.6H₂O 28.5 g/L, NaC₆H₅O₇.2H₂O 43.5 g/L, and NH₄Cl 25 g/L) to prepare a plating solution. The plating solution was added to a plating bath, and a copper substrate was immersed in the plating solution. Then, electroless plating was performed at 85° C. for 5 minutes to form a plating layer having a thickness of 0.5 μm. The copper substrate was immersed in a Pd solution (PdCl₂ 0.25 g/L, HCl 2.5 milliliters per liter (ml/L)) at room temperature for 1 minute before being immersed in the electroless plating solution to activate the surface thereof.

### Evaluation Example 1

### Scanning Electron Microscopy Evaluation of Surface Structure

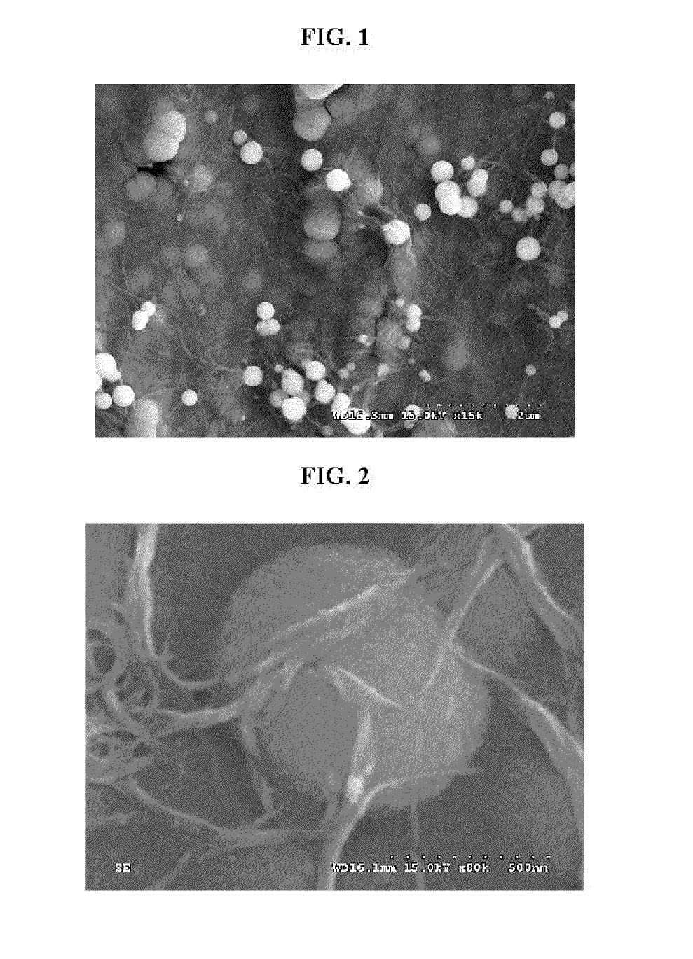

The surfaces of the plating layers prepared according to Examples 1 and 2 were observed using a scanning electron microscope (“SEM”), and the SEM images are shown in FIGS. 1 and 2. As shown in FIGS. 1 and 2, the carbon nanotubes are embedded in the Ni plating layer, and the surface has a dense structure without pores. Referring to FIG. 2, the Ni electroless plating layer includes P, which is an element of the reducing agent.

As described above, according to the one or more of the above embodiments, the carbon nanotubes and the nucleic acids are dispersed in the metal layer, and thus the metal layer has a relatively dense structure.

It should be understood that the exemplary embodiments described herein should be considered in a descriptive sense only and not for purposes of limitation. Descriptions of features, advantages or aspects within each embodiment should be considered as available for other similar features or aspects in other embodiments.

What is claimed is:

1. A composite material comprising:
a metal layer;
a plurality of carbon nanotubes in the metal layer; and
a plurality of nucleic acids in the metal layer.

2. The composite material of claim 1, wherein at least a portion of the carbon nanotubes in the metal layer is contacted with a nucleic acid over a portion of or the entirety of each of the contacted carbon nanotube.

3. The composite material of claim 2, wherein all of the carbon nanotubes in the metal layer are contacted with a nucleic acid over a portion of or the entirety of each of the contacted carbon nanotubes.

4. The composite material of claim 1, wherein the metal layer comprises at least one metal selected from the group consisting of a Group 1 to 16 element.

5. The composite material of claim 1, wherein the metal layer comprises at least one metal selected from the group consisting of
at least one alkali metal selected from the group consisting of Li, Na, K, Rb and Cs,
at least one rare-earth metal selected from the group consisting of Be, Mg, Ca, Sr and Ba,
at least one transition metal selected from the group consisting of Co, Cr, Fe, Ni, Mn, Cu, Hg, Pt, Ag, Cd, Zn, Sc, Ti, V, Y, Zr, Nb, Mo, Tc, Ru, Rh, Pd, Lu, Hf, Ta, W, Re, Os, Ir, Au, Lr, Rf, Db, Sg, Bh, Hs, Mt, Ds, Rg and Uub, and
at least one metal selected from the group consisting of Pb, Sn and Ge.

6. The composite material of claim 1, wherein the metal layer comprises a plating layer.

7. The composite material of claim 1, wherein the metal layer further comprises at least one element selected from the group consisting of P, B, N, C, O and H.

8. The composite material of claim 1, wherein the plurality of nucleic acids comprises at least one nucleic acid selected from the group consisting of DNA, complementary DNA, chloroplast DNA, multicopy single-stranded DNA, mitochondrial DNA, RNA, messenger RNA, transfer RNA, glycerol nucleic acid, locked nucleic acid, peptide nucleic acid and threose nucleic acid.

9. The composite material of claim 1, wherein the plurality of nucleic acids comprises at least one base selected from the group consisting of adenine, guanine, thymine, cytosine and uracil.

10. The composite material of claim 1, wherein the plurality of carbon nanotubes comprises at least one carbon nanotube selected from the group consisting of a single-wall carbon nanotube, a double-wall carbon nanotube, a multi-wall carbon nanotube, a metallic carbon nanotube and a semiconducting carbon nanotube.

10. The composite material of claim 1, wherein an amount of the plurality of carbon nanotubes is about 0.1% to about 80% by weight, based on the total weight of the composite material.

12. The composite material of claim 1, further comprising a substrate, wherein the metal layer is disposed on at least one surface of the substrate.

13. An electronic device comprising a composite material, wherein the composite material comprises:
a metal layer;
a plurality of carbon nanotubes in the metal layer; and
a plurality of nucleic acids in the metal layer.

14. A method of manufacturing a composite material, the method comprising:
immersing a substrate in a plating solution; and
forming a plating layer on the immersed substrate,
wherein the plating solution comprises a plurality of carbon nanotubes, a plurality of nucleic acids and a plurality of metal ions.

15. The method of claim 14, wherein the plating layer is formed by electroplating or electroless plating.

16. The method of claim 14, wherein the plating solution further comprises a reducing agent.

17. The method of claim 14, wherein at least a portion of the plurality of the carbon nanotubes contained in the plating solution is contacted with a nucleic acid over a portion or the entirety of each of the contacted carbon nanotubes.

18. The method of claim 14, wherein all of the plurality of carbon nanotubes in the metal layer are contacted with a nucleic acid over a portion of or the entirety of each of the contacted carbon nanotubes.

19. The method of claim 14, wherein the plurality of metal ions comprises at least one metal selected from the group consisting of
at least one alkali metal selected from the group consisting of Li, Na, K, Rb and Cs,
at least one rare-earth metal selected from the group consisting of Be, Mg, Ca, Sr and Ba,
at least one transition metal selected from the group consisting of Co, Cr, Fe, Ni, Mn, Cu, Hg, Pt, Ag, Cd, Zn, Sc, Ti, V, Y, Zr, Nb, Mo, Tc, Ru, Rh, Pd, Lu, Hf, Ta, W, Re, Os, Ir, Au, Lr, Rf, Db, Sg, Bh, Hs, Mt, Ds, Rg and Uub, and
at least one metal selected from the group consisting of Pb, Sn and Ge.

20. The method of claim 14, wherein the plurality of nucleic acids comprises at least one nucleic acid selected from the group consisting of DNA, complementary DNA, chloroplast DNA, multicopy single-stranded DNA, mitochondrial DNA, RNA, messenger RNA, transfer RNA, glycerol nucleic acid, locked nucleic acid, peptide nucleic acid and threose nucleic acid.

21. The method of claim 14, wherein the plurality of carbon nanotubes comprises at least one carbon nanotube selected from the group consisting of a single-wall carbon nanotube, a double-wall carbon nanotube, a multi-wall carbon nanotube, a metallic carbon nanotube and a semiconducting carbon nanotube.

22. The method of claim 14, wherein an amount of the plurality of carbon nanotubes is about 0.1% to about 60% by volume, based on the total volume of the plating solution.

23. The method of claim 14, wherein an amount of the plurality of nucleic acids is about 0.1% to about 50% by volume, based on the total volume of the plating solution.
